(19) United States
(12) Patent Application Publication
(10) Pub. No.: US 2001/0036124 A1
(43) Pub. Date: Nov. 1, 2001

(54) Beverage container with integrated stirring device

(76) Inventor: Scott Rubenstein, Nashua, NH (US)

Correspondence Address: Norman P. Soloway, HAYES, SOLOWAY, HENNESSEY, GROSSMAN & HAGE, P.C., 175 Canal Street, Manchester, NH, 03101, US

(21) Appl. No.: 09/827,691

(22) Filed: Apr. 6, 2001

Related U.S. Application Data
(60) Provisional application No. 60/196,015, filed on Apr. 7, 2000.

(51) Int. Cl. A47J 43/046

(52) U.S. Cl. 366/205; 366/314

(57) ABSTRACT

A drinking container cup, such as for coffee, tea soup or the like, having an interior and an exterior surface, said container having an integrated powered stirring device extending from the interior surface of the bottom section of the housing and driven by a small battery powered motor located in the bottom section of the housing. The bottom section and integrated stirring device are fitted with inside thread for screwing to the container and may be removed for separate cleaning or simply left in place, adding soap and turning on the stirring device. A removable lid which mechanically engages the top of the container is also provided.

### FIELD OF THE INVENTION

The present application claims benefit of U.S. Provisional Application Serial No. 60/196,015, filed Apr. 7, 2000.

The present invention relates to a beverage container with an integrated automatic stirring device, and more particularly, to a personal beverage container having a motor located in the bottom or base section of the container housing powering a stirring device extending from the interior surface of the bottom section, said bottom section being removable or fixed, the motor being controlled by an on-off button, and a removable lid which fits on top of the container. The invention has particular utility as an insulated hot or cold beverage mug or cup, and will be described in connection with such utilities, although other utilities are contemplated.

### BACKGROUND OF THE INVENTION

Beverage containers, particularly personal hot beverage mugs or cups for coffee, hot chocolate, tea or soup are well known in the art. Such mugs or cups are usually insulated and may have a removable lid with a small drinking opening and a venting hole, and often include a handle attached to the body of the mug. Typically, the user will make coffee or tea at home or purchase same at a fast food type restaurant, donut shop, convenience store or service station, mix in the desired amount of sugar and/or cream or respective substitutes therefore, put the lid on the mug and drink the coffee while driving one's automobile, commuting to work, etc. Or, in the work place or home, the user will make coffee or tea in the kitchen, mix in the desired amount of sugar and/or cream or respective substitutes therefore, and carry the cup or mug to the user's desk or workstation. Problems arise, however, with the mixing in or stirring of the added sugar and/or cream. In particular, a stirrer is needed and, in the case of a covered travel mug, the beverage must be stirred with the lid off, causing the risk of spilling the hot beverage while driving or moving. If the user forgets or loses the stirrer, he must use another object for this purpose or otherwise try to mix the contents of the cup. In addition, the wet stirrer must be disposed of or put aside for future use.

Another problem arises in maintaining uniform consistency of the beverage and the beverage additives. This usually means taking off the lid, if present, and re-stirring the contents in the container. However, this results in a repetition of the same problems, e.g., wet stirrer, etc., as faced when mixing or stirring for the first time.

In addition the container and stirring or mixing devices must be cleaned. Typically, this is accomplished by separately cleaning the housing and lid and the stirring means if not lost or discarded.

A stirring device having a stirring spoon attached to the underside of the cap of a drinking container is known from U.S. Pat. No. 5,586,676. The cap is detachable. Stirring is accomplished by removing the cap from the beverage container, holding the removed cap and manually stirring the beverage. Once stirring is completed, the cap is replaced atop the container.

A separate powered mixing or stirring device for a container such as a baby bottle is disclosed in U.S. Pat. No. 5,911,504. The ingredients are placed in the open baby bottle, the opening facing upward, the stirring apparatus is screwed on the prepared baby bottle, the bottle is rotated 180° so that the bottle is facing downward and the stirring apparatus is turned on. Once the contents have been properly mixed, the bottle is again rotated 180°, the stirring apparatus removed and the nipple attachment affixed to the baby bottle.

### SUMMARY OF THE INVENTION

It is therefore the object of the present invention to overcome the above-described disadvantages and to provide an improved beverage container having an integrated powered stirring device that eliminates the need for separate stirrers. The beverage container includes a housing having a circular base, an interior surface, an exterior surface, and a handle radiating from the exterior surface in a generally arcuate manner of appropriate shape and contour to be comfortably gripped mug-like by the hand of the user. Optionally, the beverage container may be insulated, and/or may include a removable cover or lid. In a preferred embodiment, an on-off push button control is arranged on the upper surface of the handle situated for natural access and operation by the thumb of the user.

The circular base on the container circumferentially extends from the interior and exterior surfaces of the housing and in a preferred embodiment is engagingly received by the housing by means of reciprocal threading on the inner wall of the circular base and the lower portion of the exterior surface of the housing. Preferably at least the outer surface of said circular base is comprised of a rubber like material to provide a both a secure seal and cushioning for the container. A stirring device is arranged on the upper surface of the circular base which extends into the open area of the container. The stirring device is connected via a gasketed shaft which extends through the upper surface of the base section to the stirring motor located in the circular base. A gasket or the like seals the stirring motor housed in the circular base. The stirring motor is powered by batteries or a spring, also located in the circular base.

In operation, the powered stirring device extending upward from the base section rotates with sufficient speed to automatically stir or mix the contents of the container without the need of a separate stir stick or removing or manipulating the lid, if present. In one embodiment, the stirring device may be powered by an electric motor which may optionally be powered by an automobile battery via connection, e.g., to the cigarette lighter.

An optional circular lid having downwardly descending gripping flanges and a rubber gasket fits snugly within the interior surface of the upper edge of the housing. The lid preferably is made of rubber or includes a rubber or a rubber-like material gasket to provide a watertight fit and to facilitate placement on the housing. A tab extends from the peripheral edge of the lid to allow easy removal of the lid from the upper edge of the container. Preferably the lid also has a small vent hole located near the periphery of the lid and extending through the width of the lid downward to the interior of the container and a drinking aperture or slot arranged on the opposite peripheral portion of the lid.

These and other objects, features and advantages of the present invention will be better understood with reference to the detailed description of the preferred embodiment and the accompanying drawings.

### BRIEF DESCRIPTION OF THE DRAWINGS

FIG. 1 is a perspective view of the beverage container and integrated stirring device in accordance with the present invention;

FIG. 2 is an exploded perspective view of the beverage container shown in FIG. 1;

FIG. 3 is a top view of the beverage container with the lid in place;

FIG. 4 is a top view of the circular base section of the beverage container;

FIG. 5 is a diagrammatic view of the circular base section of the beverage container in accordance with the invention;

FIG. 6 is a cross-sectional view of the circular base section and stirring according to the present invention; and

FIG. 7 is a view, similar to FIG. 6, of an alternate embodiment of the present invention.

### BRIEF DESCRIPTION OF THE PREFERRED EMBODIMENT

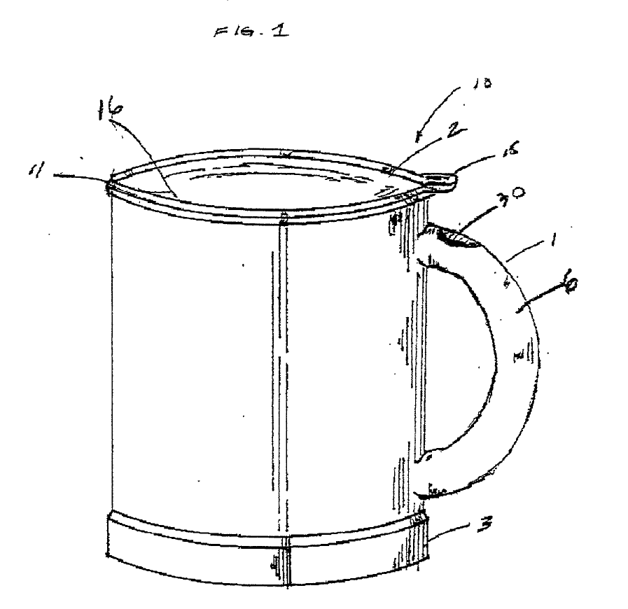

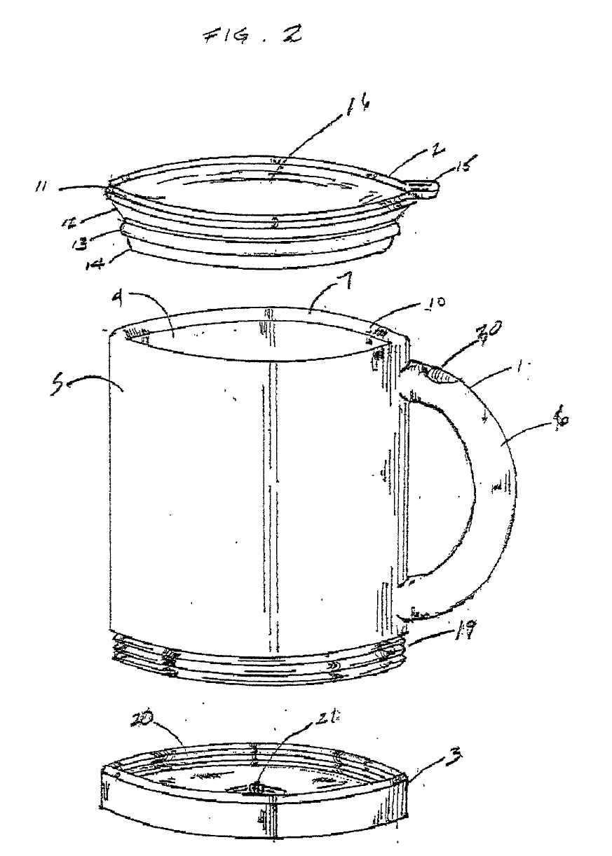

Referring to FIGS. 1 and 2, a beverage container 10 comprises a housing 1 having an interior surface 4, an exterior surface 5, and a handle 6. Handle 6 radiates from the exterior surface 5 in a generally arcuate manner shaped so as to be comfortably gripped in mug-like fashion by the hand of the user. Preferably, handle 6, which may be made of plastic or the like, has an outer surface of resilient material such as rubber or other suitable cushioning material for grasping. On-off push button 30 preferably is arranged on the upper surface of the handle 6 and is situated to provide natural access and operation by the thumb of the user. Alternatively, the on-off control 30 may be in the form of a touch sensitive button and may be located on the upper surface of the handle, or elsewhere on the container, e.g., on the side of the container. Preferably, but not necessarily, housing 1 is comprised of double wall stainless steel for durability, heat retention and safety purposes, although other suitable materials and/or single wall construction will suffice.

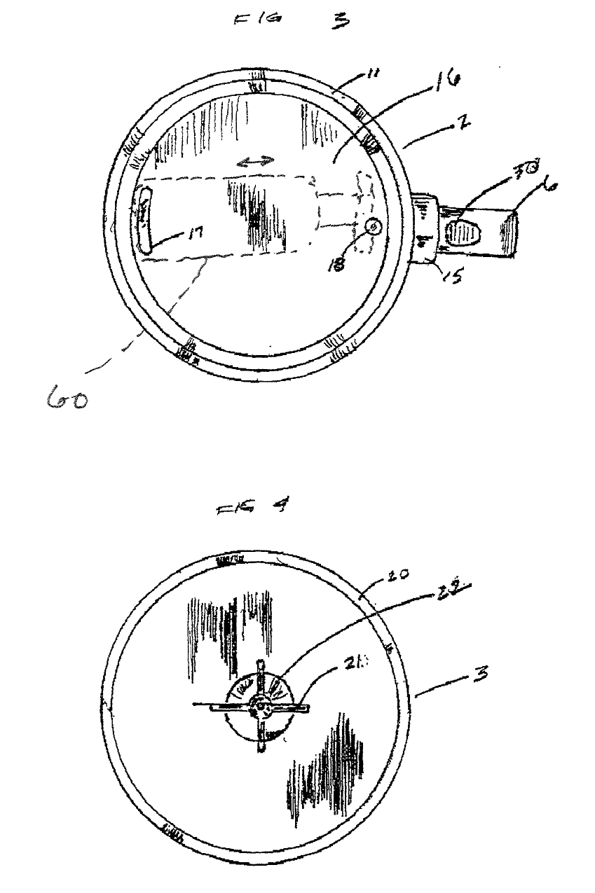

As shown in FIG. 2, circular planar lid 2 has upwardly extending inwardly angled lip 11 which sits atop and circumscribes the peripheral edge of housing 1. Inwardly angled gripping flange 12 descends downwardly from lip 11 and planar surface 16 of lid 2. A rubber gasket 13 descends in a downward fashion from the bottom of gripping flange 12, the outer edge of said rubber gasket 13 extends outwardly in a generally rounded form from the bottom of flange 12. Inwardly curved lid base 14 descends downwardly and inwardly from gasket 13. Flange 12, gasket 13 and base 14 fits snugly within the interior periphery of the upper edge of the housing 1 and are configured so as to be releasably engageable therewith. Lid 2 and circular base 3 establish a seal to the interior of housing 1 to hold the beverage. As also shown in FIGS. 2 and 3, tab 15 extends in a radial fashion from lip 11. Tab 15 facilitates the release and removal of lid 2 from the upper edge of the container. Lid 2 also has small vent hole 18 located on planar surface 16 near the periphery of the lid 2 extending through the width of lid 2 downward to the interior of container 10. Drinking aperture or slot 17 is arranged on the opposite peripheral portion of the lid. Said lid is preferably made of rubber or a rubber-like material to provide a watertight fit and to facilitate placement and removal from the housing.

As shown in FIGS. 1, 2 and 5 circular base 3 circumferentially extends from the interior and exterior surfaces of housing 1. In the preferred embodiment circular base 3 is engagingly received by housing 1 by means of reciprocal threading on the inner wall 20 of circular base 3 and on the lower portion of the exterior surface 19 of the housing. Preferably, circular base 3, which may be made of plastic, for example, has at least an outer surface of rubber or similar resilient material to provide a secure seal for the container and to also provide suitable cushioning and gripping for the bottom surface of the base. Alternatively, circular base 3 may be integrally coupled to housing 1.

As is shown in FIG. 4, stirring device 21 is centrally arranged on the upper surface of circular base 3 and extends upwardly into the open area of housing 1. In the preferred embodiment, stirring device 21 is comprised of plastic and has a generally propeller-like in shape, although other configurations are possible.

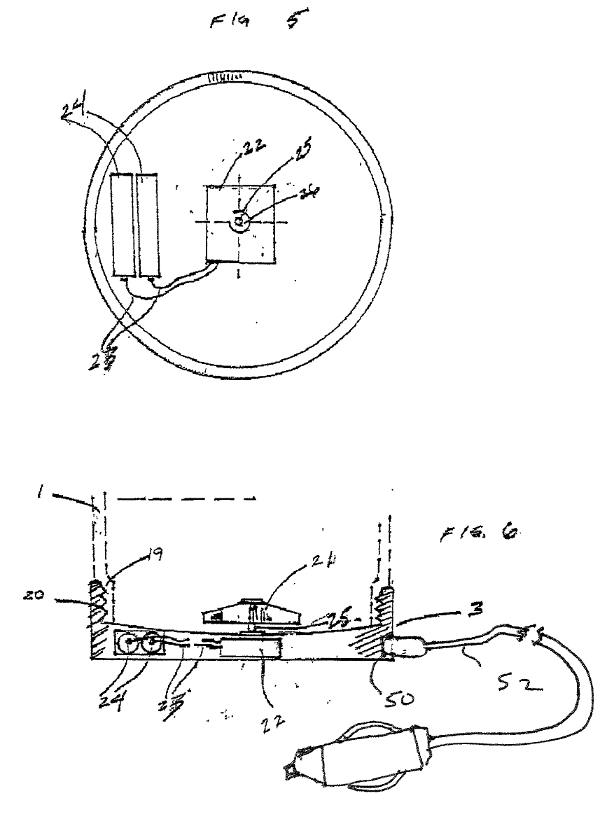

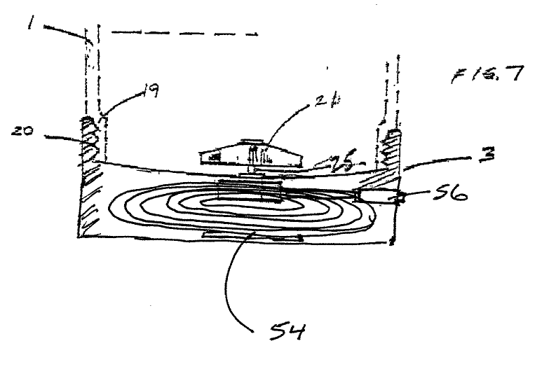

Referring now to FIGS. 5 and 6, stirring device 21 is connected to shaft 25 which extends through rubber gasket 26 arranged beneath the stirring device on the upper surface of circular base 3 sealing shaft 25 and a battery powered stirring motor 22 located below in circular base 3. Shaft 25 is attached to motor 22 which is powered by batteries 24 also disposed in circular base 3 and connected to motor 22 by wires 23. In operation, motor 22 drives shaft 25 which causes stirring device 21 to rotate with sufficient speed so as to stir or mix the contents of the container without the need of a separate stir stick or removing or manipulating the lid. Optionally or additionally, plug 50 may be provided in base 3 so that the stirring motor 22 may be powered by the automobile battery via a conventional cord plug connection 52 to, e.g., an automobile cigarette lighter (not shown). In yet another alternative embodiment, the stirring device may be powered by a rechargeable battery housed within the circular base similarly chargeable through plug connection 52. FIG. 6 also shows the threading on inner wall 20 of circular base 3 engagingly received by reciprocal threading on the lower portion of the exterior surface 19 of the beverage container. Also, when the beverage container is designed to be used as a travel mug, other forms of lids, e.g., having an outlet covered by a snap type closure and/or a spring tethered valve (shown in phantom in FIG. 3 at 60), that allows a user to slide open the valve, e.g. with the thumb, take a sip, and release the slide to allow the lid to tightly close and thus not spill, may be used. In addition, circular base 3 may be removed for separate cleaning, or, alternatively, simply left in place, adding soap and water and turning on the stirring device. This latter cleaning feature is a particular advantage, e.g. in the office environment or the like, where the user may not have access to a dishwasher. The self-stirring beverage container also has novelty value, and may be used, for example, to encourage children to drink pulp-containing juice, flavored milk, or even to keep a medicine suspended in a beverage to make taking the medicine more tolerable.

Although described in terms of the presently preferred embodiment, the present invention is not limited to the embodiment described. For example, as shown in FIG. 7, the stirring device 21 may be powered by a spring motor 54 and a mechanical slide or detent switch 56 or the like housed in the base 3. Still other changes may be made without departing from the sprit and scope of the invention.

What is claimed is:

1. A beverage container comprising, in combination:
a housing providing an interior space and coupled to a base;
a stirring motor housed in the base, said stirring motor including a rotatable shaft extending from the motor through a gasket into the interior space;
a stirring device mounted on the shaft in the interior space;
an energy source for powering said motor;
a switch for selectively activating said motor; and
a removable lid mounted on the open end of said container.

2. The beverage container as claimed in claim 1, wherein the stirring motor comprises an electric motor.

3. The beverage container according to claim 2, wherein the energy source for the electric motor comprises batteries.

4. The beverage container according to claim 3, wherein the batteries are mounted in the base.

5. The beverage container according to claim 4, wherein the batteries comprise rechargeable batteries.

6. The beverage container according to claim 3, and further including a detachable cord for connecting the electric motor to a remote battery.

7. The beverage container according to claim 1, wherein the container also includes a handle, and wherein the switch is located on the handle.

8. The beverage container according to claim 7, wherein the switch is located on a top surface of the handle so that it may be readily accessible by the thumb of a person gripping the handle.

9. The beverage container according to claim 1, wherein the stirring motor comprises a spring powered motor.

10. The beverage container according to claim 9, wherein the switch comprises a mechanical slide switch.

11. The beverage container according to claim 1, wherein the housing is threadably mounted on the base.

12. The beverage container according to claim 1, wherein the lid includes a tab for facilitating release and removal from the housing.

13. The beverage container according to claim 1, wherein the lid includes a vent hole.

14. The beverage container according to claim 1, and further comprising a gasket carried on the lid for sealing the lid to the housing.

15. The beverage container according to claim 1, wherein the housing comprises a double wall housing.

16. The beverage container according to claim 1, wherein the lid includes an outlet covered by a valve or closure.

17. A beverage container comprising, in combination:
a housing providing an interior space and coupled to a base;
a stirring motor housed in the base, said stirring motor including a rotatable shaft extending from the motor through a gasket into the interior space;
a stirring device mounted on the shaft in the interior space;
an energy source for powering said motor;
a handle; and
a switch for selectively activating said motor located on said handle.

18. The beverage container as claimed in claim 17, wherein the stirring motor comprises an electric motor.

19. The beverage container according to claim 18, wherein the energy source for the electric motor comprises batteries.

20. The beverage container according to claim 19, wherein the batteries are mounted in the base.

21. The beverage container according to claim 20, wherein the batteries comprise rechargeable batteries.

22. The beverage container according to claim 19, and further including a detachable cord for connecting the electric motor to a remote battery.

23. The beverage container according to claim 17, wherein the switch is located on a top surface of the handle so that it may be readily accessible by the thumb of a person gripping the handle.

24. The beverage container according to claim 17, wherein the stirring motor comprises a spring powered motor.

25. The beverage container according to claim 24, wherein the switch comprises a mechanical slide switch.

26. The beverage container according to claim 17, wherein the housing is threadably mounted on the base.

27. The beverage container according to claim 17, wherein the lid includes a tab for facilitating release and removal from the housing.

28. The beverage container according to claim 17, wherein the lid includes a vent hole.

29. The beverage container according to claim 17, and further comprising a gasket carried on the lid for sealing the lid to the housing.

30. The beverage container according to claim 17, wherein the housing comprises a double wall housing.

31. The beverage container according to claim 17, wherein the lid includes an outlet covered by a valve or closure.
